(19) United States
(12) Patent Application Publication
(10) Pub. No.: US 2008/0037176 A1
(43) Pub. Date: Feb. 14, 2008

(54) Disk apparatus

(75) Inventors: Yoshiharu Matsuda, Kawasaki (JP); Hisashi Kaneko, Kawasaki (JP); Masaya Suwa, Kawasaki (JP); Toru Watanabe, Kawasaki (JP); Takuma Kido, Kawasaki (JP); Yasuo Suzuki, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/650,678

(22) Filed: Jan. 5, 2007

(30) Foreign Application Priority Data
Aug. 10, 2006 (JP) 2006-218814

(51) Int. Cl. G11B 5/54

(52) U.S. Cl. 360/254.8

(57) ABSTRACT

A disk apparatus includes a ramp which holds a tip end of an arm at a position away from a disk, and a slit shroud having an airflow control plate. A side surface of the airflow control plate is opposed to a side surface of the disk, the airflow control plate spreads to a position where the airflow control plate is superposed on the tip end of the arm held by the ramp. The airflow control plate has the same thickness as that of the disk, and is flush with the disk 12.

### BACKGROUND OF THE INVENTION

1. Field of the Invention

The present invention relates to a disk apparatus which positions a head above a rotating disk and which accesses the disk.

2. Description of Related Art

Conventionally, magnetic disk apparatuses are provided in computers externally or internally and in recent years, the magnetic disk apparatuses are incorporated not only in computers, but also in video cassette recorders, digital cameras, car navigation systems and the like.

The magnetic disk apparatuses are roughly divided into a type called CSS (contact stop start) type, and a type called load/unload type. According to the CSS type, a magnetic head which accesses a magnetic disk is left on the magnetic disk. In the case of this CSS type, if the magnetic disk rotates, the magnetic head slightly floats up from the magnetic disk surface by airflow caused by the rotation, and the magnetic head accesses the magnetic disk in this state.

On the other hand, according to the load/unload type, when the rotation of the magnetic disk is stopped, the magnetic head is moved to a position separated from an outer periphery of the magnetic disk (this is called unload) on standby, and when the magnetic disk is rotated, the magnetic head is moved to a position above the magnetic disk (this is called load).

Conventionally, the CSS type was mainstream. But a surface roughness of the magnetic disk has become smaller as the packing density of the magnetic disk has become higher through the years. Thus, stiction troubles that the magnetic disk is adsorbed as it is if the magnetic head once comes into contact with the magnetic disk surface are more likely to occur.

In the case of movable device such as a notebook personal computer provided with the magnetic disk apparatus therein, since the computer is carried frequently, high impact resistance is required. In the case of the CSS type, since the magnetic head comes into contact with the magnetic disk, there is a problem that the CSS type is disadvantageous for the impact.

From such a reason, in recent years, the load/unload type magnetic disk apparatus is widely employed. In the case of the load/unload type, since the magnetic head is on standby at a position away from the magnetic disk when the operation is stopped, high impact resistance can be maintained as compared with the CSS type.

FIG. 1 is a schematic diagram showing a structure of a load/unload type magnetic disk apparatus from which an upper cover is detached.

This magnetic disk apparatus 10A includes a magnetic disk 12 which is rotated around a rotation shaft 11 in a direction of arrow A by a disk control motor (DCM) (not shown).

The magnetic disk apparatus 10A includes an arm 15 which is provided at its tip end with a magnetic head 13 (see FIG. 2) opposed to the magnetic disk 12, and which turns around the rotation shaft 14. The magnetic disk apparatus 10A also includes a voice coil motor (VCM) 16 which turns the arm 15 and moves the magnetic head 13 in a radial direction of the magnetic disk 12. The magnetic disk apparatus 10A also includes a drying agent activated carbon unit (AD unit) 17 for keeping air in the apparatus dry.

The magnetic disk apparatus 10A also includes a ramp 20A which holds a tip end of the arm 15 at the time of unloading motion.

When data is written in the magnetic disk 12 or data stored in the magnetic disk is read, the arm 15 is turned by the voice coil motor 16 in a state where the magnetic disk 12 is rotated by the disk control motor, the arm 15 is released from the held state of the ramp 20A shown in FIG. 1, the magnetic head 13 (see FIG. 2) provided on the tip end of the arm 15 moves to a position above the magnetic disk 12 (load). When the magnetic head 13 is positioned above a desired track on the magnetic disk 12, data is sequentially written magnetically as the magnetic head 13 rotates, or data is sequentially picked up magnetically. If the writing operation into the magnetic disk 12 or the reading operation from the magnetic disk 12 is completed, the arm 15 is unloaded to a position shown in FIG. 1 and is held by the ramp 20A, and the rotation of the magnetic disk 12 is stopped.

FIG. 2 is a schematic diagram of a structure of the tip end of the arm 15 shown in FIG. 1.

The arm 15 includes a carriage 151 extending from the rotation shaft of the arm 15, and a suspension 152 which is provided at its tip end with the magnetic head 13. A rear end of the suspension 152 is attached to the tip end of the carriage 151, and the suspension 152 further extends from the tip end of the carriage 151. The magnetic head 13 includes a gimbal 131 which is rockably supported on the tip end of the suspension 152, and a slider 132 which is supported by the gimbal 131.

If the arm 15 is loaded to a position above the magnetic disk 12, the slider 132 very slightly floats up from the magnetic disk 12, information is written in the magnetic disk 12 or read from the magnetic disk 12 by an element which directly accesses the magnetic disk 12 provided on a portion of the slider 132.

FIG. 3 is an enlarged plan view of the ramp 20A and the tip end of the arm 15 of the magnetic disk apparatus 10A. FIG. 4 is a perspective view of the ramp 20A. The arm 15 is formed at its foremost end with a horn 153. The horn 153 is supported by a support surface 211 provided on a tongue 21 of the ramp 20A at the time of unloading. Since both first surface and second surface of the magnetic disk 15 are accessed, the arm 15 has two arms, i.e., an arm having a magnetic head opposed to the first surface of the magnetic disk 15 and an arm having a magnetic head opposed to the second surface of the magnetic disk 15, and these two arms vertically superposed and extended. At the time of unloading, the horns 153 of these two arms are supported by two support surfaces 121 which are upper and lower surfaces of the tongue 21 of the ramp 20A.

The magnetic disk apparatus needs to keep a state where the magnetic disk and magnetic head are extremely close to each other. Therefore, stability of rotation of the magnetic disk, and moving stability of the magnetic head at the time of loading and unloading are important. Especially, with size-reducing tendency and weight-reducing tendency of late years, the adverse possibility that unstably motion is generated due to a slight wind is increasing.

Japanese Utility Model Publication No. 55-169670, Japanese Patent Applications Laid-open Nos. 2000-228079, 2004-152373 and 2004-234984 propose techniques for controlling airflow generated when a magnetic disk rotates, thereby enhancing the stability of a magnetic disk or a magnetic head which accesses the magnetic disk.

Techniques disclosed in Japanese Utility Model Publication No. 55-169670, Japanese Patent Applications Laid-open Nos. 2000-228079, 2004-152373 and 2004-234984 are for improving the rotation stability of the magnetic disk and the running performance of the magnetic head which accesses the magnetic disk. In the case of the load/unload type, the environment of the magnetic head is abruptly varied between a case where the magnetic head is above the magnetic disk and a case where the magnetic head is in a location away from the magnetic disk. If only the magnetic disk is stably rotating, there is a possibility that the magnetic head comes into contact with the magnetic disk at the time of loading or unloading. In the four conventional techniques are based on the CSS type magnetic disk apparatus, and the stability of the magnetic head at the time of loading and unloading is not taken into consideration.

That is, airflow is generated on the disk surface and around the disk by rotation of the magnetic disk, but each suspension receives direct hit due to concourse of air flows from the magnetic disks at an end of the outer periphery of the magnetic disk and from disturbance of the airflow in other path at a location away from the disk surface, each magnetic head vertically or laterally vibrates, stability of the floating position of the magnetic head with respect to the magnetic disk and stability of the position of the magnetic head with respect to the ramp are influenced at the time of loading and unloading.

### SUMMARY OF THE INVENTION

The present invention has been made in view of the above circumstances and provides a disk apparatus in which stability of a head at the time of loading and unloading is enhanced. The disk apparatus in which an arm turns, thereby moving a tip end of the arm in a direction along a disk surface between a position where the tip end is opposed to the disk and a position away from the disk, the arm is provided at the tip end with a head, and when the head is positioned above the rotating disk, the head accesses the disk, wherein the disk apparatus includes:

a ramp which holds the tip end of the arm at a position away from the disk; and

an airflow control plate which spreads at least from a vicinity of a side surface of the disk to a position where the airflow control plate is opposed to the tip end of the arm held by the ramp.

Since the disk apparatus of the invention includes the airflow control plate which spreads at least from a vicinity of the side surface of the disk to the position where the airflow control plate is opposed to the tip end of the arm held by the ramp, vertical airflow around an outer periphery of the disk and near the disk at the time of loading and unloading of the head is shut off. Thus, the load/unload operation of the head is carried out under the stably environment, and the possibility of contact of the head with the disk is largely reduced.

In the disk apparatus of the invention, it is preferable that the arm includes a carriage extending from a turning center of the arm, and a suspension whose rear end is attached to a tip end of the carriage and which extends from the tip end of the carriage, and which is provided at its tip end with the head, the airflow control plate spreads such as to cover the suspension from a rear end portion of the suspension attached to the carriage to a tip end of the suspension in the extending direction of the arm.

If the airflow control plate is formed into the shape which extending along the locus of the suspension while the head loads or unloads, adverse influence caused by the airflow can reliably be prevented.

In the disk apparatus of the invention, it is preferable that the airflow control plate has the same thickness as that of the disk, and the airflow control plate is flush with the disk.

Since the airflow control plate is flush with the disk, it is possible to more reliably prevent the disturbance of airflow.

In the disk apparatus of the invention, the airflow control plate may be provided in an airflow control member disposed adjacent to the ramp.

If the airflow control plate and the ramp are provided on separate members, the airflow control plate can be provided without changing shape of the ramp having actual results.

When the airflow control plate is provided in an airflow control member which is different from the ramp, it is preferable that the airflow control member has a relief groove which is opposed to two surfaces of the ramp, i.e., a surface of the ramp which is separated from the disk, and a surface of the ramp facing the turning center of the arm, the relief groove avoids interference with respect to the ramp.

If the relief groove is formed, it is possible to bring the airflow control plate close to the ramp as close as possible, and to suppress the vibration caused by airflow at the time of loading and unloading of the head.

When the airflow control plate is provided in an airflow control member which is different from the ramp, it is preferable that the disk apparatus further includes a support body which supports both the ramp and the airflow control member, a portion of the airflow control member which covers a surface of the ramp separated from the disk is fastened to the support body, and when this fastening is loosened, the airflow control member can turn around the portion.

If the common support body is provided, the assembling operation can be carried out while maintaining the high precision positional relation between the ramp and the airflow control member. If the airflow control member can turn, the positioning operation of the ramp and the airflow control member at the time of assembling operation of the drive becomes easy.

In the disk apparatus of the invention, it is preferable that the airflow control plate and the ramp are made of the same member.

If the airflow control plate and the ramp are made of the same member, the number of components is reduced, and the assembling operation is facilitated.

When the airflow control plate is provided in the same member as a member of which the ramp is formed, it is preferable that the head has a slider which floats up from the disk surface, the airflow control plate has a shape which further spreads while including a region opposed to the entire region of the slider in a state in which the tip end of the arm is held by the ramp. Further, it is preferable that the arm includes a carriage extending from a turning center of the arm, and a suspension whose rear end is attached to a tip end of the carriage and which extends from the tip end of the carriage, and which is provided at its tip end with the head, the head includes a gimbal which is rockably supported by a tip end of the suspension, and a slider supported by the gimbal, the airflow control plate has a shape which further spreads toward the turning center of the arm than an end of the gimbal on the side of the turning center of the arm in a state where the tip end of the arm is held by the ramp.

If the airflow control plate further spreads while including the region opposed to the entire region of the slider, the stability of airflow is enhanced. If the airflow control plate has a shape which further spreads toward the turning center of the arm than an end of the gimbal on the side of the turning center of the arm, the stability of airflow is further enhanced.

When the airflow control plate and the ramp are made of the same member, it is preferable that a side surface of the airflow control plate on the side of the disk is opposed to a side surface of the disk, and the airflow control plate extends while keeping a constant gap between the airflow control plate and the side surface of the disk.

Since a disk rotates, the airflow control plate cannot be brought into contact with the disk. Hence, the side surface of the airflow control plate is opposed to the side surface of the disk, the airflow control plate extends while having the constant gap between the airflow control plate and the side surface of the disk. With this, it is possible to suppress the disturbance of the airflow as small as possible.

According to the present invention, it is possible to stabilize the environment of the head at the time of loading and unloading, to reduce the contact possibility of the head with a disk at the time of loading and unloading, and to prevent a disk and a head from being damaged. Therefore, there liability of the disk apparatus is enhanced and lifetime thereof is increased.

### BRIEF DESCRIPTION OF THE DRAWINGS

FIG. 1 is a schematic diagram showing a state of a load/unload type magnetic disk apparatus from which an upper cover is detached;

FIG. 2 is a schematic diagram showing a structure of a tip end of an arm shown in FIG. 1;

FIG. 3 is an enlarged plan view of a ramp and a tip end of the arm of the magnetic disk apparatus shown in FIG. 1;

FIG. 4 is a perspective view of the ramp;

FIG. 5 is a schematic plan view showing a state of a load/unload type magnetic disk apparatus of a first embodiment of the present invention from which an upper cover is detached;

FIG. 6 is an enlarged plan view of a ramp and a tip end of an arm of the magnetic disk apparatus shown in FIG. 5;

FIG. 7 is a perspective view of the ramp shown in FIG. 6;

FIG. 8 is a diagram showing results of vibration measurement in a comparative example and the embodiment of the invention;

FIG. 9 is a schematic diagram showing a state of a magnetic disk apparatus of a second embodiment of the present invention from which an upper cover is detached;

FIG. 10 is a partial enlarged perspective view a ramp and a slit shroud of the magnetic disk apparatus shown in FIG. 9;

FIG. 11 is a sectional view of the ramp and the slit shroud shown in FIG. 10 taken along the longitudinal direction of the arm; and

FIG. 12 is a sectional perspective view of the cross section shown in FIG. 11 as viewed from a diagonal direction.

### DETAILED DESCRIPTION OF THE INVENTION

Embodiments of the present invention will be explained below.

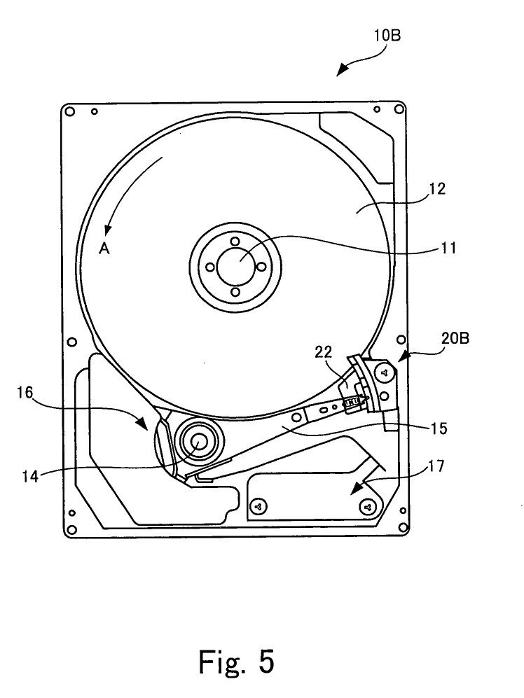

FIG. 5 is a schematic plan view showing a state of a load/unload type magnetic disk apparatus of a first embodiment of the present invention from which an upper cover is detached.

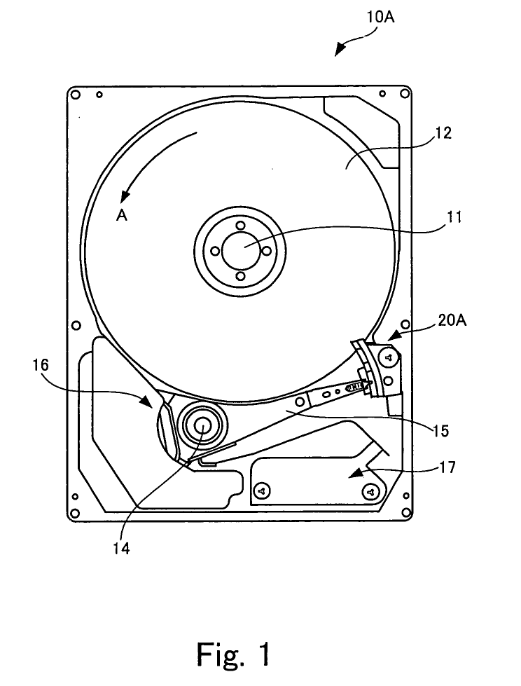

A magnetic disk apparatus 10B shown in FIG. 5 is different from the magnetic disk apparatus shown in FIG. 1 only in shape of the ramp. Therefore, common elements are shown with the same symbols as those in FIG. 1, and redundant explanation will be omitted.

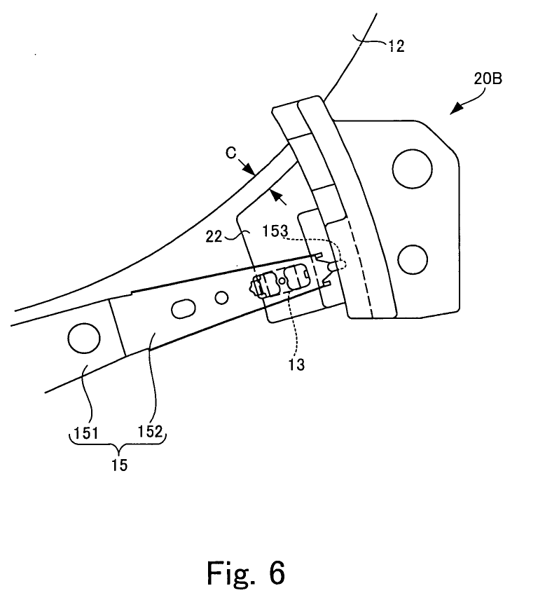

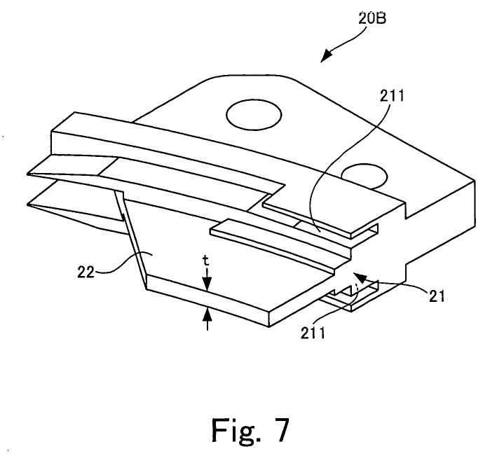

FIG. 6 is an enlarged plan view of a ramp 20B and a tip end of an arm 15 of the magnetic disk apparatus 10B shown in FIG. 5. FIG. 7 is a perspective view of the ramp 20B.

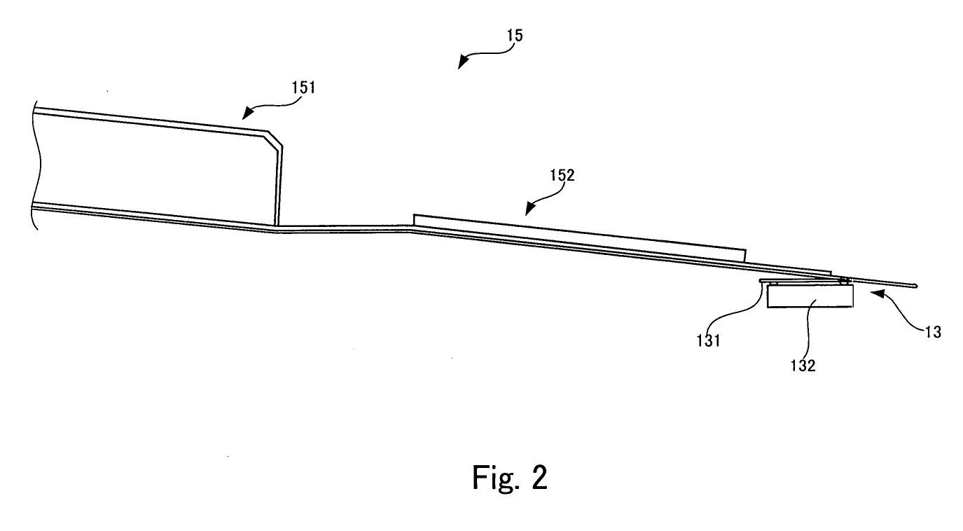

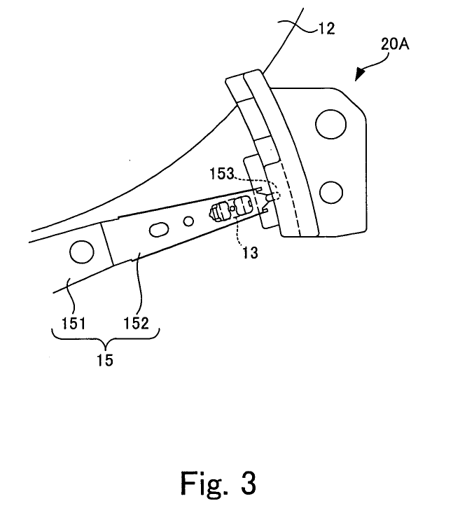

As compared with the magnetic disk apparatus 10A explained with reference to FIGS. 1 to 4, the structure of the arm (see FIG. 2) is the same, and the structure of the ramp is different.

The ramp 20B of the magnetic disk apparatus 10B of this embodiment includes an airflow control plate 22 widening from a tongue 21 toward a rotation shaft 14 of the arm 15 (see FIG. 5) as shown in FIGS. 6 and 7.

As shown in FIG. 6, a side surface of the airflow control plate 22 on the side of the magnetic disk 12 is opposed to a side surface of the magnetic disk 12, and the airflow control plate 22 extends such that a constant gap c is formed between the airflow control plate 22 and the side surface of the magnetic disk 12.

A thickness t of the airflow control plate 22 shown in FIG. 7 is the same as a thickness of the magnetic disk 12, and is also position at the same level (in a direction perpendicular to a paper sheet of FIG. 5) as the level of the magnetic disk 12. Therefore, the front and back surfaces of the airflow control plate 22 are respectively flush with the front and back surfaces of the magnetic disk 15.

The airflow control plate 22 has a shape which is further widened while including a region opposed to the entire region of a slider 132 (see FIG. 2) when a horn 153 of a tip end of the arm 15 is supported by the ramp 20B in an unload state, and has a shape where a portion toward a rotation shaft 14 (see FIG. 5) of the arm 15 is wider than the side of a gimbal 131 facing the rotation shaft 14 (see FIG. 2). With this, the airflow in a region through which the air passes at the time of loading and unloading of the magnetic head is stabilized, and the load/unload operation of the magnetic head is stabilized.

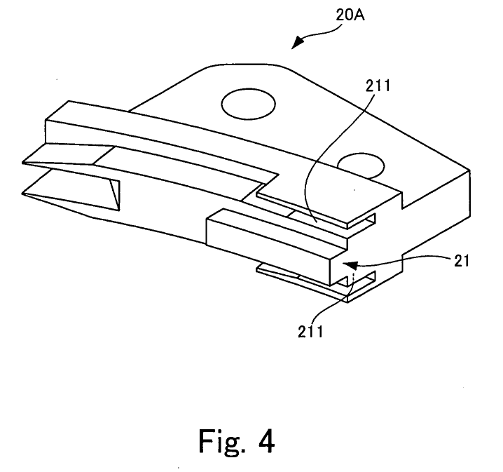

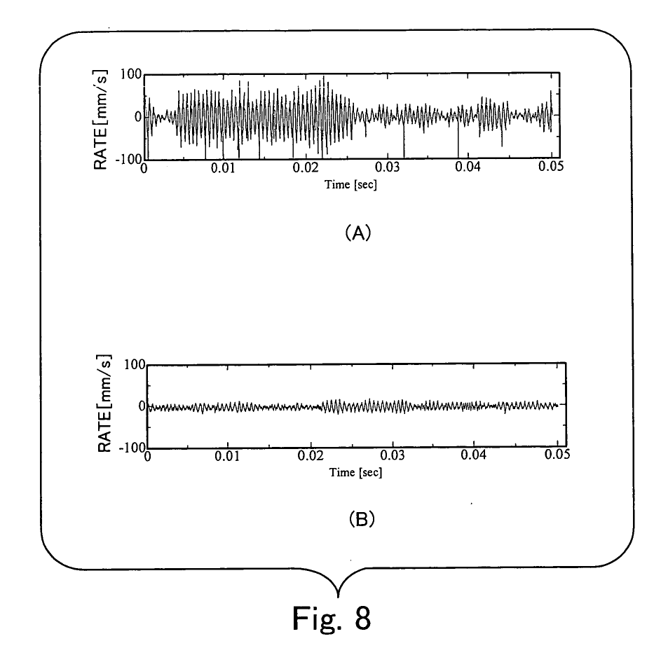

FIG. 8 shows measurement results of vibration of a comparative example (part (A) of FIG. 8) and the embodiment (part (B) of FIG. 8) of the invention. Here, there are shown measurement results of vibration of the slider 132 (see FIG. 2) measured by a laser vibrometer in the unload state of the magnetic disk apparatus 10A (part (A) of FIG. 8) having the ramp 20A of structure shown in FIG. 4 and the magnetic disk apparatus 10B (part (B) of FIG. 8) having the ramp 20B of a structure shown in FIG. 7.

As apparent from comparison between parts (A) and (B) of FIG. 8, the airflow control plate 22 largely suppresses the vibration of the head.

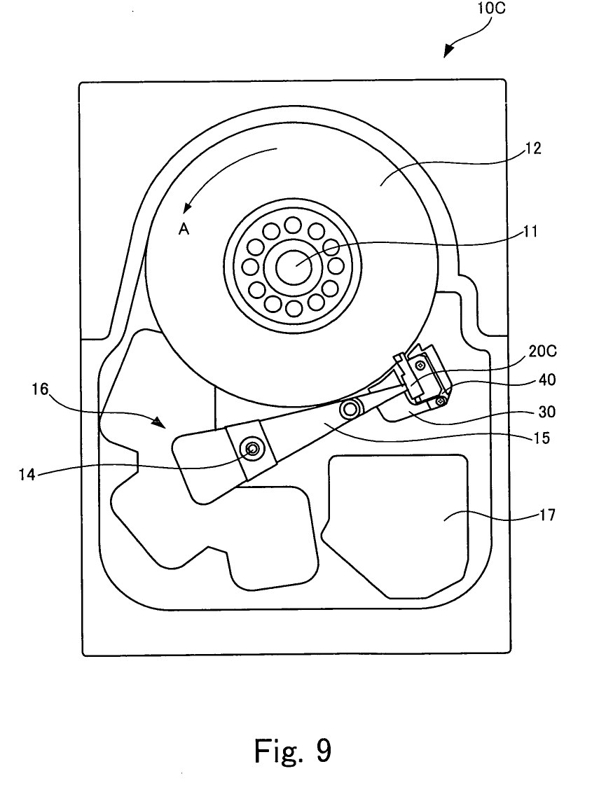

FIG. 9 is a schematic diagram showing a state of a magnetic disk apparatus of a second embodiment of the present invention from which an upper cover is detached.

Elements having the same functions as those of the magnetic disk apparatuses 10A and 10B shown in FIGS. 1 and 5 are designated with the same symbols as those shown in FIG. 1 even through shapes thereof are different. Only essential different points will be explained.

In a magnetic disk apparatus 10C shown in FIG. 9, four magnetic disks 12 having the same shapes are coaxially superposed on one another at predetermined distances from one another. The magnetic disks 12 are rotated simultaneously in the direction of arrow A. Correspondingly, the same number of arms 15 as that of the magnetic heads which access first surfaces and second surfaces of the four magnetic disks 12 are formed, and the arms 15 are turned simultaneously.

A magnetic disk apparatus 10 includes a ramp 20C for holding a tip end of each arm 15 at the time of unload, a slit shroud 30 for maintaining the running stability of the arm 15 at the time of loading and unloading, and a support member 40 to which both the ramp 20C and the slit shroud 30 are fixed by means of screw and which supports both the ramp 20C and the slit shroud 30.

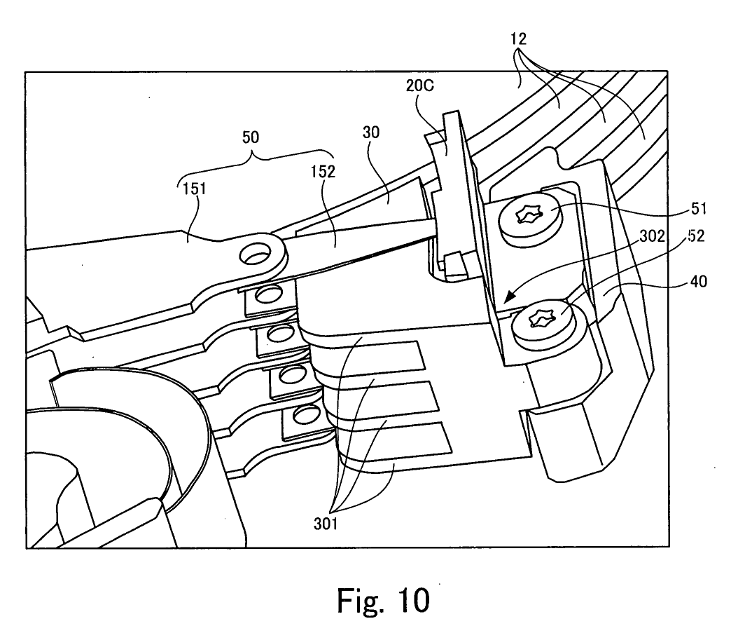

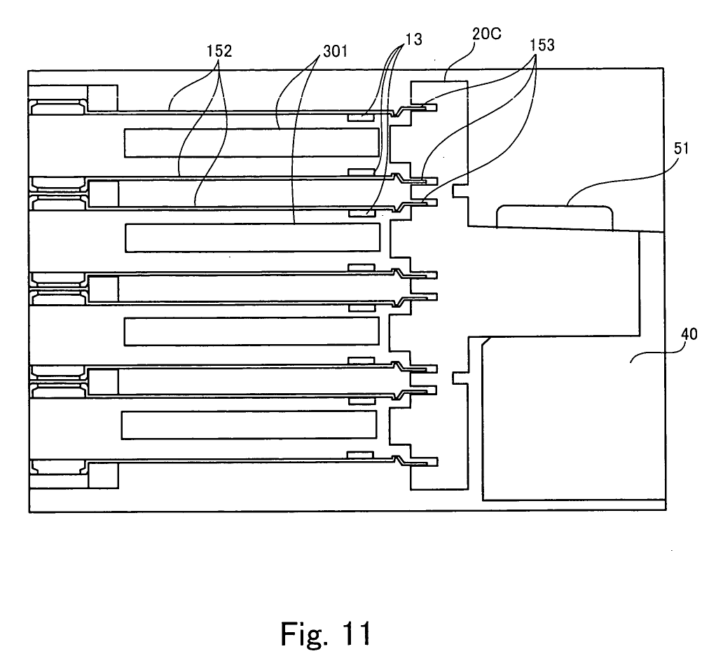

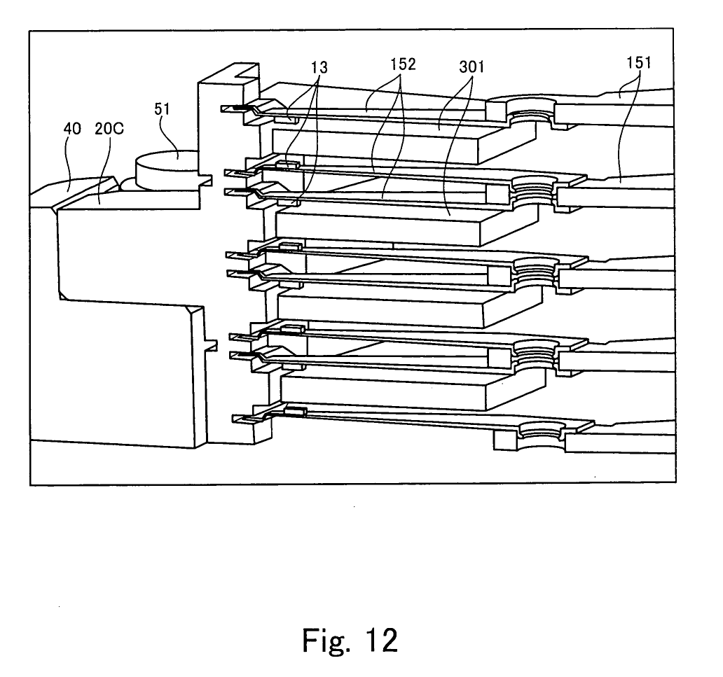

FIG. 10 is a partial enlarged perspective view of the ramp 20C and the slit shroud 30 of the magnetic disk apparatus 10C shown in FIG. 9. FIG. 11 is a sectional view of the ramp 20C and the slit shroud 30 shown in FIG. 10 taken along the longitudinal direction of the arm 15. FIG. 12 is a sectional perspective view of the cross section shown in FIG. 11 as viewed from a diagonal direction.

The ramp 20C and the slit shroud 30 are formed as independent parts, and they are fixed in parallel to the common support member 40 provided on a base constituting a case of the magnetic disk apparatus 10C by means of screws 51 and 52. With this, positioning of the ramp 20C and the slit shroud 30 is carried out precisely.

The arm 15 (see FIG. 9) comprises a carriage 151 of the arm 15 on the side of the rotation shaft 14, and a suspension 152 whose rear end is attached to a tip end of the carriage 151 and which further extends from the tip end of the carriage 151. As shown in FIGS. 11 and 12, the magnetic head 13 is provided on a surface of the suspension 152 that is opposed to the magnetic disk 12.

Corresponding to the number (four) of the magnetic disks 12, the slit shroud 30 is formed with four airflow control plates 301 in a form of comb.

As shown in FIG. 10, side surfaces of the four airflow control plates 301 respectively approach side surfaces of the magnetic disks 12 and are opposed thereto, and the airflow control plates 301 spread to positions where they are superposed on the suspension 152 constituting the arms 15 held by the ramp 20C.

That is, the airflow control plates 301 spread in at least the moving direction of the suspension 152 from a portion of the outer peripheral side surface of the disk 12 to a position where the airflow control plates 301 face the suspension 152 held in the ramp completion position. Each airflow control plate 301 of the slit shroud 30 extends such as to cover the longitudinal direction from a portion in the vicinity of a tip end of the suspension 152 to a portion in the vicinity of a mounting end of the carriage 151.

Therefore, by forming the airflow control plate 301 of the slit shroud 30 into the shape that is as close as possible to the shape formed along the locus of the suspension 152 which moves on the ramp 20C from a ramp opening-start position to a ramp completion position, it is possible to reliably prevent the influence of airflow. In this embodiment, the suspension 152 is made of material having elasticity, and the carriage 151 is made of material having rigidity. Therefore, in this case, it is preferable that at least the suspension 152 has such a shape that it is not influenced by airflow.

To prevent the influence of airflow on the carriage 151, the slit shroud 30 may have such a shape that it extends close to the rotation shaft 14.

Since the disk apparatus has the airflow control plate 301, it is possible to shut off the vertical airflow at and near an outer peripheral end of each magnetic disk surface at the time of loading and unloading of the magnetic head of the tip end of the suspension 152. Therefore, the environment of the magnetic head 13 is stabilized, the load/unload operation is carried out stably under the stable environment, and the possibility of contact of the magnetic head 13 to the magnetic disk is largely reduced.

The slit shroud 30 is disposed very close to the side surface of the ramp 20C. The airflow control plate 301 is provided with a relief groove 302 (see FIG. 10) such as to avoid the interference with the ramp 20C. Therefore, the airflow control plate 301 of the slit shroud 30 can be close to the side surface of the ramp 20C as close as possible, and influence of airflow in the vicinity of the magnetic head 30 of the tip end of the suspension 152 is suppressed.

The slit shroud 30 can rotate with respect to a support body 40 around the screw 52 in a state where the screw 52 is loosened. Therefore, the positioning operations of the ramp 20C and the arm 50 are facilitated when the disk apparatus is assembled.

The suspension 152 loads and unloads along the upper surfaces of the four airflow control plates 301, in the slit sandwiched between the airflow control plates 301 and along the lower surfaces of the airflow control plates 301.

Each of the airflow control plates 301 has the same thickness as that of one magnetic disk 12, and has the same surface as that of the magnetic disk 12. Therefore, environment such as strength of wind and a direction of wind at the time of loading and unloading of the arm 15 (suspension 152) is substantially similar to the environment on the magnetic disk 12, and the load/unload operation is carried out stably while avoiding generation of unintentional wind.

Although the present invention has been explained based on the magnetic disk apparatus, the invention is not limited to the magnetic disk apparatus, and the invention can be applied also to a disk apparatus comprising a disk and a head with the same structure.

What is claimed is:

1. A disk apparatus in which an arm turns, thereby moving a tip end of the arm in a direction along a disk surface between a position where the tip end is opposed to the disk and a position away from the disk, the arm is provided at the tip end with a head, and when the head is positioned above the rotating disk, the head accesses the disk, the disk apparatus comprising:
a ramp which holds the tip end of the arm at a position away from the disk; and
an airflow control plate which spreads at least from a vicinity of a side surface of the disk to a position where the airflow control plate is opposed to the tip end of the arm held by the ramp.

2. The disk apparatus according to claim 1, wherein the arm includes a carriage extending from a turning center of the arm, and a suspension whose rear end is attached to a tip end of the carriage and which extends from the tip end of the carriage, and which is provided at a tip end with the head,
the airflow control plate spreads such as to cover the suspension from a rear end portion of the suspension attached to the carriage to a tip end of the suspension in the extending direction of the arm.

3. The disk apparatus according to claim 1, wherein the airflow control plate is flush with has the same thickness as that of the disk, and the airflow control plate is flush with the disk.

4. The disk apparatus according to claim 1, wherein the airflow control plate is provided in an airflow control member disposed adjacent to the ramp.

5. The disk apparatus according to claim 4, wherein the airflow control member has a relief groove which is opposed to two surfaces of the ramp, i.e., a surface of the ramp which is separated from the disk, and a surface of the ramp facing the turning center of the arm, and the relief groove avoids interference with respect to the ramp.

6. The disk apparatus according to claim 5, further comprising a support body which supports both the ramp and the airflow control member,
wherein a portion of the airflow control member which covers a surface of the ramp separated from the disk is fastened to the support body, and when this fastening is loosened, the air flow control member can turn around the portion.

7. The disk apparatus according to claim 1, wherein the airflow control plate and the ramp are made of the same member.

8. The disk apparatus according to claim 7, wherein the head has a slider which floats up from the disk surface,
the airflow control plate has a shape which further spreads while including a region opposed to the entire region of the slider in a state in which the tip end of the arm is held by the ramp.

9. The disk apparatus according to claim 7, wherein the arm includes a carriage extending from a turning center of the arm, and a suspension whose rear end is attached to a tip end of the carriage and which extends from the tip end of the carriage, and which is provided at a tip end with the head,
the head includes a gimbal which is rockably supported by a tip end of the suspension, and a slider supported by the gimbal,
the airflow control plate has a shape which further spreads toward the turning center of the arm than an end of the gimbal on the side of the turning center of the arm in a state where the tip end of the arm is held by the ramp.

10. The disk apparatus according to claim 7, wherein a side surface of the airflow control plate on the side of the disk is opposed to a side surface of the disk, and the airflow control plate extends while keeping a constant gap between the airflow control plate and the side surface of the disk.
